(19) United States
(12) Patent Application Publication
(10) Pub. No.: US 2019/0342203 A1
(43) Pub. Date: Nov. 7, 2019

(54) SYSTEM AND METHOD FOR OPTIMIZING ROUTING OF TRANSACTIONS OVER A COMPUTER NETWORK

(71) Applicant: SOURCE Ltd, Valletta (MT)

(72) Inventors: Moshe SELFIN, Haifa (IL); Ilya DUBINSKY, Kefar Sava (IL); Dana LEVY, Tel Aviv (IL); Ben ARBEL, Pardes Hana (IL); Tal REGEV, Haifa (IL)

(73) Assignee: SOURCE Ltd, Valletta (MT)

(21) Appl. No.: 15/968,771

(22) Filed: May 2, 2018

(51) Int. Cl. H04L 12/751; G06N 3/08; G06Q 20/10

(52) U.S. Cl. CPC H04L 45/08; G06Q 20/10; G06N 3/08

(57) ABSTRACT

A method and a system for routing transactions within a computer network may include receiving a request to route a transaction between two nodes of the computer network, extracting a feature vector (FV) from the transaction request, including at least one feature associated with the requested transaction; associating the requested transaction with a cluster of transactions in a clustering model based on the extracted FV; selecting an optimal route for the requested transaction from a plurality of available routes, based on the FV; and routing the requested transaction according to the selection.

### FIELD OF THE INVENTION

The present invention relates to data transfer. More particularly, the present invention relates to systems and methods for optimizing data routing in a computer network.

### BACKGROUND OF THE INVENTION

Data transfer in computer systems is typically carried out in a single format (or protocol) from a first node to a second predetermined node of the computer system. In order to transfer data of different types (or different protocols) to the same end point, different computer systems are typically required with each computer system carrying out data transfer in a different data format.

Moreover, while current computer systems have complex architecture with multiple computing nodes, for instance all interconnected via the internet (e.g., in a secure connection), data routing is not optimized. For example, transferring a video file between two computers, or transferring currency between two bank accounts, is typically carried out in a session with a single format and routed within the computer network without consideration to minimal resource consumption.

In the financial field, modern merchants, in both online and offline stores, often utilize a payment services provider that supports a single, uniform interface (with a single format) towards the merchant but can connect to multiple payment methods and schemes on the back end. Payment service providers relay transactions to other processing entities and, ultimately, transaction processing is handled by one or more banks that collect the funds, convert currency, handle possible disputes around transactions and finally transfer the money to merchant account(s).

A payment service provider may be connected to multiple banks located in different geographic areas, which can process the same payment instruments but under varying local rules. Furthermore, different banks can provide different currency conversion rates and pay merchants at varying frequencies and with varying fund reserve requirements. In addition to financial differences, banks and processing solutions may differ in quantity of approved transactions (decline rates), quantity of fraud-related transactions that solutions fail to identify and quantity of disputes that occur with regard to these transactions later. Merchants may have different preferences with regards to the characteristics of their processing solution. Some would prefer to pay as little as possible, dealing with occasional fraud case but seeing higher approval rates, while others would prefer to be conservative with regards to fraud, even at expense of higher transaction fees.

### SUMMARY OF THE INVENTION

Embodiments of the present invention include a system and a method for routing transactions between nodes of a computer network, in which each node may be connected to at least one other node via one or more links. The system may include for example a clustering model; at least one neural network; a routing engine; and at least one processor.

The at least one processor may be configured to: receive a request to route a transaction between two nodes of the computer network; extract from the transaction request, a feature vector (FV), comprising at least one feature; and associate the requested transaction with a cluster of transactions in the clustering model based on the extracted FV.

The neural network may be configured to produce a selection of an optimal route for the requested transaction from a plurality of available routes, based on the FV, and the routing engine may be configured to route the requested transaction through the computer network according to the selection.

According to some embodiments, the clustering model may be configured to: accumulate a plurality of FVs, each including at least one feature associated with a respective received transaction; cluster the plurality of FVs to clusters, according to the at least one feature; and associate at least one other requested transaction with a cluster, according to a maximum-likelihood best fit of the at least one other requested transaction's FV.

The at least one processor may be configured to attribute at least one group characteristic (GC) to the requested transaction, based on the association of the requested transaction with the cluster. The neural network may be configured to produce a selection of an optimal route for the requested transaction from a plurality of available routes, based on at least one of the FV and GC.

According to some embodiments, the GC may be selected from a list consisting of: decline propensity, fraud propensity, chargeback propensity and expected service time.

According to some embodiments, the neural network may be configured to select an optimal route for the requested transaction from a plurality of available routes, based on at least one of the FV and GC and at least one weighted user preference.

The at least one processor may be configured to calculate at least one cost metric. The neural network may be configured to select an optimal route for the requested transaction from a plurality of available routes, based on at least one of the FV and GC, at least one weighted user preference, and the at least one calculated cost metric.

According to some embodiments, the at least one cost metric may be selected from a list consisting of: transaction fees per at least one available route, currency conversion spread and markup per the at least one available route and net present value (NPV) of the requested transaction per at least one available route.

According to some embodiments, each cluster of the clustering model may be associated with a respective neural network module, and each neural network module may be configured to select at least one routing path for at least one specific transaction associated with the respective cluster.

Embodiments of the invention may include a method of routing transactions within a computer network. The method may include: receiving, by a processor, a request to route a transaction between two nodes of the computer network, each node connected to at least one other node via one or more links; extracting from the transaction request, an FV, including at least one feature associated with the requested transaction; associating the requested transaction with a cluster of transactions in a clustering model based on the extracted FV; selecting an optimal route for the requested transaction from a plurality of available routes, based on the FV; and routing the requested transaction according to the selection.

According to some embodiments, associating the requested transaction with a cluster may include: accumulating a plurality of FVs, each including at least one feature associated with a respective received transaction; clustering the plurality of FVs to clusters in the clustering model, according to the at least one feature; and associating at least one other requested transaction with a cluster according to a maximum-likelihood best fit of the at least one other requested transaction's FV.

According to some embodiments, attributing at least one GC to the requested transaction may include: calculating at least one GC for each cluster; and attributing the received request the at least one calculated GC based on the association of the requested transaction with the cluster.

According to some embodiments, selecting an optimal route for the requested transaction from a plurality of available routes may include: providing at least one of an FV and a GC as a first input to a neural-network; providing at least one cost metric as a second input to the neural-network; providing the plurality of available routes as a third input to the neural-network; and obtaining, from the neural-network a selection of an optimal route based on at least one of the first, second and third inputs.

According to some embodiments, providing at least one cost metric may include at least one of: calculating transaction fees per at least one available route; calculating currency conversion spread and markup per the at least one available route; and calculating net present value of the requested transaction per at least one available route. Embodiments may further include receiving at least one weight value and determining the cost metric per the at least one available route based on the calculations and the at least one weight value.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device, according to some embodiments of the invention;

FIG. 2 is a block diagram of a transaction routing system, according to some embodiments of the invention;

FIG. 3A and FIG. 3B are block diagrams, presenting three different examples for routing of transactions through nodes of a computer network, according to some embodiments of the invention;

FIG. 4 is a block diagram of a transaction routing system, according to some embodiments of the invention;

FIG. 5 is a block diagram, depicting an exemplary implementation of a neural network according to some embodiments; and

FIG. 6 is a flow diagram, depicting a method of routing transactions through a computer network according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

According to some embodiments, methods and systems are provided for routing transactions in a computer network. The method may include: receiving a request to route a transaction between two nodes of the computer network, each node connected via a link; automatically determining at least one characteristic and/or type of the requested transaction; and selection of an optimal route from a plurality of available routes for the requested transaction, in accordance with the determined characteristic and/or type and in accordance with available resources of the computer network to route data between the two nodes. In some embodiments, the calculated at least one route includes at least one node other than the two nodes.

The following Table 1 includes a list of terms used throughout this document, alongside respective definitions of the terms, for the reader's convenience:

TABLE 1

| | |
|---|---|
| Node | The term ‘Node’ is used herein to refer to a computerized system, |
| | used for processing and/or routing transactions within a network |
| | of nodes. Nodes may include, for example: an individual |
| | computer, a server in an organization and a site operated by an |
| | organization (e.g. a data center or a server farm operated by an |
| | organization). For example, in Monetary Exchange (ME) |
| | transactions, nodes may include a server in a banking system, a |
| | computer of a paying-card issuer, etc. |
| Transaction | The term ‘transaction’ is used herein to refer to communication of |
| | data between a source node and a destination node of a computer |
| | network. |
| | According to some embodiments, transactions may include a |
| | single, one-way transfer of data between the source node and the |
| | destination node. For example: a first server may propagate at |
| | least one data file to a second server as a payload within a |
| | transaction. |
| | Alternately, transactions may include a plurality of data transfers |
| | between the source node and the destination node. For example, a |
| | transaction may be or may include a monetary exchange between |
| | two institutions (such as banks), operating computer servers and |
| | computer equipment, where in order to carry out the transaction |
| | data needs to be transferred between the servers and other |
| | computer equipment operated by the institutions. |
| Transaction | The term ‘Payload’ is used herein to refer to at least one content of |
| payload | a transaction that may be sent from the source node to the |
| | destination node. Payloads may include, for example: information |
| | included within the transaction (e.g. parameters of a financial |
| | transaction, such as a sum and a currency of a monetary |
| | exchange), a data file sent over the transaction, etc. |
| Transaction | The term “Transaction request” is used herein to refer to a request |
| request | placed by a user, for a transaction between a source node and a |
| | destination node of a computer network. For example, a user may |
| | initiate a request to perform a monetary exchange transaction, |
| | between a source node (e.g. a server of a first bank) and a |
| | destination node (e.g. a server of a second bank). |
| User | The term ‘User’ is used herein to refer to an individual or an |
| | organization that places at least one transaction request. According |
| | to some embodiments, the user may be associated with a profile, |
| | including at least one user preference, and data pertaining to |
| | previous transaction requests placed by the user. |
| Transaction | The term “Feature Vector” (FV) is used herein to refer to a data |
| feature vector | structure, including a plurality of parameters associated with a |
| (FV) | transaction request. |
| | For example, transactions may be characterized by parameters |
| | such as: payload type, data transfer protocol, source node, |
| | destination node, etc. The FV may include at least one of these |
| | parameters in a data structure for farther processing. |
| Transaction | The term “Transaction cluster” is used herein to refer to an |
| cluster | aggregation of transactions according to transaction FVs. |
| | Transaction clusters may, for example, be obtained by inputting a |
| | plurality of FVs, each associated with a specific transaction |
| | request, to an unsupervised clustering model. Embodiments may |
| | subsequently associate at least one other (e.g. new) requested |
| | transaction to one cluster of the clustering model, as known to |
| | persons skilled in the art of machine learning. |
| Group | The term “Group characteristics” is used herein to refer to at least |
| Characteristics | one characteristic of a group of transactions. |
| (GCs) | Pertaining to the example of monetary exchange transactions, GCs |
| | may include: availability of computational resources, an expected |
| | servicing time, a fraud propensity or likelihood, a declined |
| | propensity, a chargeback propensity, etc. |
| | According to some embodiments, at least one GC may be |
| | attributed to at least one transaction cluster. For example, a |
| | processor may analyze the servicing time of all transactions within |
| | a transaction cluster and may attribute these transactions as having |
| | a long expected servicing time. |
| Routing path | The term “Routing path” is used herein to refer to a path through |
| | nodes and links of the computer network, specified by the system |
| | for propagation of a transaction between a source node and a |
| | target node of a computer network. |
| | Embodiments may include identifying a plurality of available |
| | routing paths for propagation of a transaction between a source |
| | node and a target node of a computer network, as known to |
| | persons skilled in the art of computer networks. |
| Cost metrics | The term “Cost metrics” is used herein to refer to a set of metrics |
| | that may be used to evaluate different available routing paths, to |
| | select an optimal routing path. |
| | Pertaining to the example of ME transactions, cost metrics may |
| | include at least one of: a transaction fee per at least one available |
| | route, currency conversion spread and markup per the at least one |
| | available route, and Net Present Value (NPV) per at least one |
| | available route. |

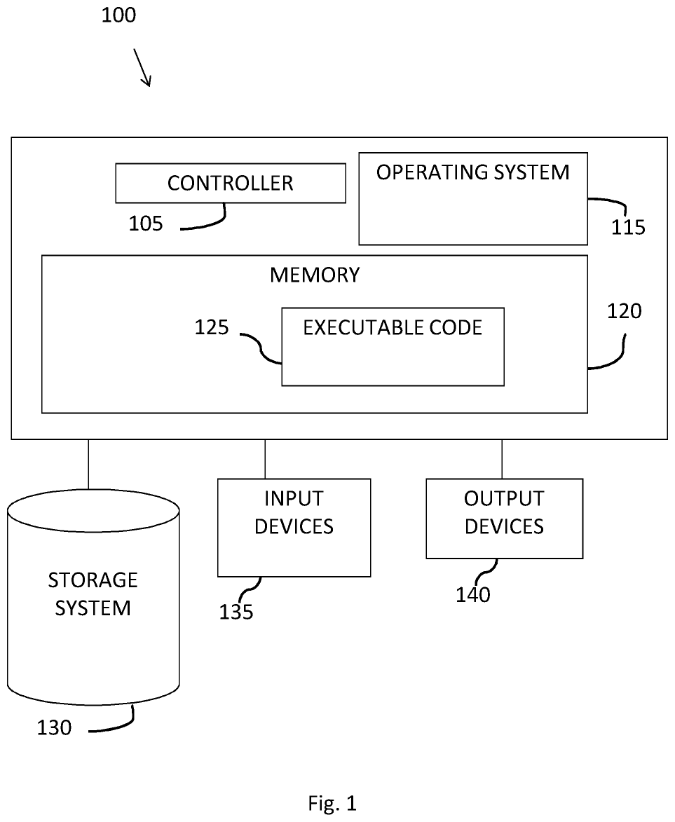

Reference is made to FIG. 1, which shows a block diagram of an exemplary computing device, according to some embodiments of the invention. A device 100 may include a controller 105 that may be, for example, a central processing unit processor (CPU), a chip or any suitable computing or computational device, an operating system 115, a memory 120, executable code 125, a storage system 130 that may include input devices 135 and output devices 140. Controller 105 (or one or more controllers or processors, possibly across multiple units or devices) may be configured to carry out methods described herein, and/or to execute or act as the various modules, units, etc. More than one computing device 100 may be included in, and one or more computing devices 100 may act as the components of, a system according to embodiments of the invention.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or tasks or enabling software programs or other modules or units to communicate. Operating system 115 may be a commercial operating system. It will be noted that an operating system 115 may be an optional component, e.g., in some embodiments, a system may include a computing device that does not require or include an operating system 115. For example, a computer system may be, or may include, a microcontroller, an application specific circuit (ASIC), a field programmable array (FPGA) and/or system on a chip (SOC) that may be used without an operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein.

Storage system 130 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in storage system 130 and may be loaded from storage system 130 into memory 120 where it may be processed by controller 105. In some embodiments, some of the components shown in FIG. 1 may be omitted. For example, memory 120 may be a non-volatile memory having the storage capacity of storage system 130. Accordingly, although shown as a separate component, storage system 130 may be embedded or included in memory 120.

Input devices 135 may be or may include any suitable input devices, components or systems, e.g., a detachable keyboard or keypad, a mouse and the like. Output devices 140 may include one or more (possibly detachable) displays or monitors, speakers and/or any other suitable output devices. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140. It will be recognized that any suitable number of input devices 135 and output device 140 may be operatively connected to computing device 100 as shown by blocks 135 and 140. For example, input devices 135 and output devices 140 may be used by a technician or engineer in order to connect to a computing device 100, update software and the like. Input and/or output devices or components 135 and 140 may be adapted to interface or communicate.

Embodiments of the invention may include a computer readable medium in transitory or non-transitory form comprising instructions, e.g., computer-executable instructions, which, when executed by a processor or controller, cause the processor or controller to carry out methods disclosed herein. For example, embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 105.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of chips, FPGAs or SOCs, a plurality of computer or network devices, or any other suitable computing device. For example, a system as described herein may include one or more devices such as the computing device 100.

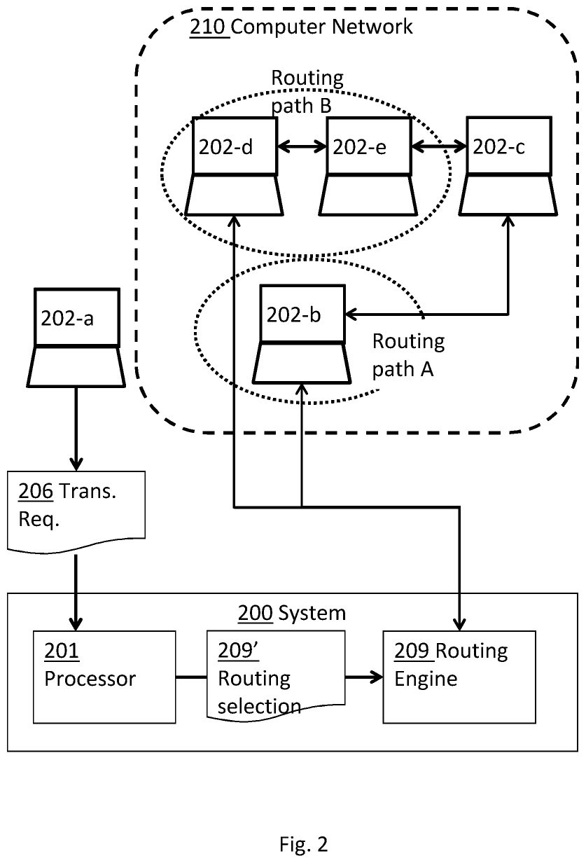

Reference is made to FIG. 2 which is a block diagram, depicting a non-limiting example of the function of a transaction routing system 200, according to some embodiments of the invention. The direction of arrows in FIG. 2 may indicate the direction of information flow in some embodiments. Of course, other information may flow in ways not according to the depicted arrows.

System 200 may include at least one processor 201 (such as controller 105 of FIG. 1) in communication (e.g., via a dedicated communication module) with at least one computing node (e.g. element 202-a).

According to some embodiments, system 200 may be centrally placed, to control routing of a transaction over network 210 from a single location. For example, system 200 may be implemented as an online server, communicatively connected (e.g. through secure internet connection) to computing node 202-a. Alternately, system 200 may be directly linked to at least one of node e.g. 202-a.

In yet another embodiment, system 200 may be implemented as a plurality of computational devices (e.g. element 100 of FIG. 1) and may be distributed among a plurality of locations. System 200 may include any duplication of some or all of the components depicted in FIG. 2. System 200 may be communicatively connected to a plurality of computational nodes (e.g. 202-a) to control routing of transactions over network 210 from a plurality of locations.

In some embodiments, computing nodes 202-a thru 202-e of computer network 210 may be interconnected, where each node may be connected to at least one other node via one or more links, to enable communication there between. In some embodiments, each computing node 202 may include memory and a dedicated operating system (e.g., similar to memory 120 and a dedicated operating system 115 as shown in FIG. 1).

As shown in FIG. 2, system 200 may receive a transaction request 206, to perform a transaction between a source node (e.g., 202-a) and a destination node (e.g.: 202-c). According to some embodiments, processor 201 may be configured to: analyze transaction request 206 (as explained further below); identify one or more available routing paths (e.g. route A and route B) that connect the source node and destination node; and select an optimal routing path (e.g. route A) for the requested transaction.

According to some embodiments, processor 201 may be configured to produce a routing path selection 209′, associating the requested transaction with the selected routing path. System 200 may include a routing engine 209, configured to receive routing path selection 209′ from processor 201, and determine or dictate the routing of requested transaction 206 in computer network 210 between the source node (e.g.: 202-a) and destination node (e.g.: 202-c) according to the routing path selection.

As known to persons skilled in the art of computer networking, dictation of specific routes for transactions over computer networks is common practice. In some embodiments, routing engine 209 may determine or dictate a specific route for transaction by utilizing low-level functionality of an operating system (e.g. element 115 of FIG. 1) of a source node (e.g. 202-a) to transmit the transaction over a specific network interface (e.g. over a specific communication port) to an IP address and port of a destination node (e.g. 202-c). For example, routing engine 209 may include specific metadata in the transaction (e.g. wrap a transaction payload in a Transmission Control Protocol (TCP) packet) and send the packet over a specific pre-established connection (e.g. TCP connection) to ensure that a payload of the transaction is delivered by lower-tier infrastructure to the correct destination node (e.g. 202-c), via a selected route.

Embodiments of the present invention present an improvement to routing algorithms known in the art, by enhancing the selection of an optimal routing path from a plurality of available routes. Routing algorithms known in the art are normally configured to select a routing path according to a predefined set, consisting a handful of preselected parameters (e.g. a source node address, a destination node address, a type of a service and a desired Quality-of-Service (QoS)). Embodiments of the present invention may employ algorithms of artificial intelligence (AI) to dynamically select optimal routing paths for requested transactions, according to constantly evolving ML models that may not be limited to any set of input parameters, or to any value of a specific input parameter, as explained further below.

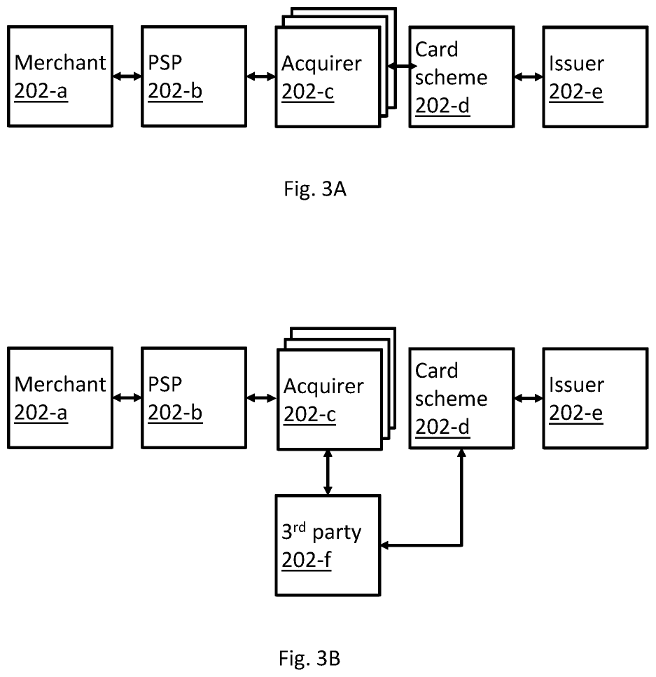

Reference is made to FIG. 3A and FIG. 3B, which are block diagrams presenting three different examples for routing ME transactions through nodes of a computer network, according to parameters of the payload, e.g. financial transaction. In each of the depicted examples, a merchant may require settling a financial transaction through transfer of a monetary value, between the merchant's bank account, handled by node 202-c in an acquirer bank and a consumer's bank account handled by node 202-e in an issuer bank.

The examples depicted in FIG. 3A and FIG. 3B may differ in the selected route due to different parameters of the financial transaction, including for example: a method of payment, predefined security preferences as dictated by the merchant, a maximal NPV of the financial transaction (e.g. due to delays in currency transfer imposed by policies of a payment card issuer), etc.

FIG. 3A depicts a non-limiting example of an e-commerce transaction involving a payment card (e.g. a credit card or a debit card), in which the merchant has dictated a high level of security. For example: the merchant may have preselected to verify the authenticity of the paying card's Card Verification Code (CVC), perform 3D Secure authentication, perform address verification, etc. The transaction may therefore be routed according to the routing path, as described below.

From the merchant's computer 202-a, the transaction may be routed to a payment service provider (PSP) 202-b, which offers shops online services for accepting electronic payments by a variety of payment methods, as known to persons skilled in the art of online banking methods.

From PSP 202-b, the transaction may be routed to the acquirer node 202-c, where, for example, the merchant's bank account is handled. In some embodiments, the merchant may be associated with a plurality of acquirer nodes 202-c and may select to route the transaction via one of the acquirer nodes 202-c for example to maximize profit from a financial transaction.

For example: the paying-card holder may have his account managed in US dollars. The merchant may be associated with two bank accounts, (e.g. two respective acquirer nodes 202-c), in which the merchant's accounts are managed in Euros. Embodiments may enable the merchant to select a route that includes an acquirer node 202-c that provides the best US Dollar to Euro currency exchange rate.

In another example, a card holder may perform payment through various methods, including for example, a merchant's website or a telephone order (e.g. a consumer may order pizza through a website, or by dictating the paying-card credentials through the phone). Banks may associate a different level of risk to each payment method and may charge a different percentage of commission per each financial transaction, according to the associated risk. Assuming the merchant is associated with two bank accounts, (e.g. two respective acquirer nodes 202-c), where a first bank imposes lower commission for a first payment method, and a second bank imposes lower commission for a second payment method. Embodiments may enable the merchant to route the transaction through an acquirer node 202-c according to the payment method, to incur the minimal commission for each transaction.

From acquirer node 202-c, the transaction may be routed to a card scheme 202-d, which, as known to persons familiar in the art of online banking, is a payment computer network linked to the payment card, and which facilitates the financial transaction, including for example transfer of funds, production of invoices, conversion of currency, etc., between the acquirer bank (associated with the merchant) and the issuer bank (associated with the consumer). Card scheme 202-d may be configured to verify the authenticity of the paying card as required by the merchant (e.g. verify the authenticity of the paying card's Card Verification Code (CVC), perform 3D Secure authentication, perform address verification, etc.).

From card scheme 202-d, the transaction may be routed to issuer node 202-e, in which the consumer's bank account may be handled, handle the payment.

From issuer node 202-e, the transaction may follow in the track of the routing path all the way back to merchant node 202-a, to confirm the payment.

FIG. 3B depicts a non-limiting example for a card-on-file ME transaction, in which a consumer's credit card credentials may be stored within a database or a secure server accessible by the merchant, (e.g. in the case of an autopayment of recurring utilities bills, or a recurring purchase in an online store). As known to persons skilled in the art of online banking, card-on-file transaction do not require the transfer paying-card credentials from the merchant to the acquirer 202-c. Instead, a token indicative of the paying-card's number may be stored on merchant 202-a, and a table associating the token with the paying-card number may be stored on a third-party node 202-f.

As shown in FIG. 3B, PSP 202-b addresses 202-f and requests to translate the token to a paying-card number, and then forwards the number to acquirer 202-c, to authorize payment.

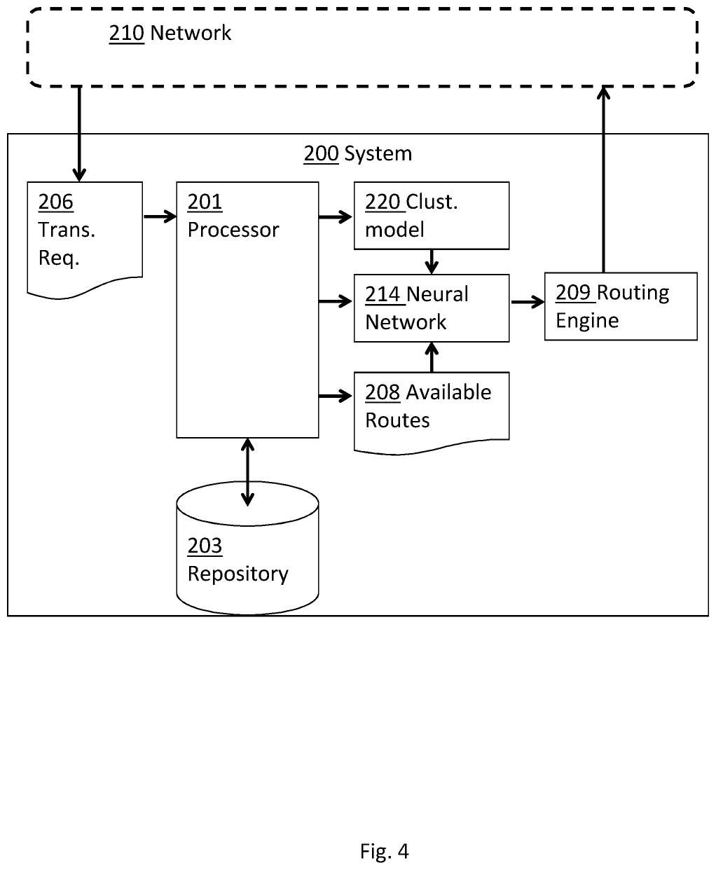

Reference is made to FIG. 4 which shows a block diagram of a transaction routing system 200, according to some embodiments of the invention. The direction of arrows in FIG. 4 may indicate the direction of information flow.

System 200 may include at least one repository 203, in communication with the at least one processor 201. Repository 203 may be configured to store information relating to at least one transaction, at least one user and at least one route, including for example: Transaction FV, Transaction GC, cost metrics associated with specific routes, and User preferences. In some embodiments, routing of transactions between the computing nodes 202 of computer network 210 may be optimized in accordance with the data stored in repository 203, as explained further below.

According to some embodiments, processor 201 may be configured to receive at least one transaction request, including one or more data elements, to route a transaction between two nodes of the computer network. For example, processor 201 may receive an ME transaction requests, associated with a paying card (e.g. a credit card or debit card). The ME request may include data pertaining to parameters such as:

Transaction sum;

Transaction currency;

Transaction date and time (e.g.: in Coordinated Universal Time (UTC) format);

Bank Identification Number (BIN) of the paying card's issuing bank;

Country of the paying card's issuing bank;

Paying card's product code;

Paying card's Personal Identification Number (PIN);

Paying card's expiry date

Paying card's sequence number

Destination terminal (e.g. data pertaining to a terminal in a banking computational system, which is configured to maintain the payment recipient's account);

Target merchant (e.g. data pertaining to the payment recipient);

Merchant category code (MCC) of the payment recipient;

Transaction type (e.g.: purchase, refund, reversal, authorization, account validation, capture, fund transfer);

Transaction source (e.g. physical terminal, mail order, telephone order, electronic commerce and stored credentials);

Transaction subtype (e.g.: magnetic stripe, magnetic stripe fallback, manual key-in, chip, contactless and Interactive Voice Response (IVR)); and

Transaction authentication (e.g.: no cardholder verification, signature, offline PIN, online PIN, no online authentication, attempted 3D secure, authenticated 3D secure).

Other or different information may be used, and different transactions may be processed and routed.

According to some embodiments, processor 201 may extract from the transaction request an FV, including at least one feature associated with the requested transaction. For example, the FV may include an ordered list of items, where each item represents at least one data element of the received transaction request.

Examples for representation of data element of the received transaction request as items in an FV may include:

Destination terminals may be represented by their geographic location (e.g. the destination terminal's geographical longitude and latitude as stored in a terminal database).

The Transaction type, source, subtype and authentication may be represented by mapping them into a binary indicator vector, where each position of the vector may correspond to a specific sort of transaction type/source/subtype/authentication and may be assigned a ‘1’ value if the transaction belongs to a specific type/source/subtype/authentication and ‘0’ otherwise.

According to some embodiments, system 200 may include a clustering model 220, consisting of a plurality of transaction clusters. Clustering model 220 may be configured to receive a plurality of feature vectors (FVs), each associated with a respective transaction request, and each including at least one feature associated with the respective transaction request. Clustering model 220 may cluster the plurality of transaction requests to at least one transaction cluster, according to the at least one feature.

As known to persons skilled in the art of AI, the outcome of non-supervised clustering may not be predictable. However, clusters may be expected to group together items of similar features. Pertaining to the example of ME transactions, clusters may evolve to group together e-commerce purchase transactions made with payment cards of a particular issuer, transactions involving similar amounts of money, transactions involving specific merchants, etc.

According to some embodiments, clustering module 220 may be implemented as a software module, and may be executed, for example, by processor 201. Alternately, clustering module 220 may be implemented on a computational system that is separate from processor 201 and may include a proprietary processor communicatively connected to processor 201.

According to some embodiments, clustering module 220 may apply an unsupervised, machine learning expectation-maximization (EM) algorithm to the plurality of received FVs, to produce a set of transaction clusters, where each of the plurality of received FVs is associated with one transaction cluster, as known to persons skilled in the art of machine learning.

According to some embodiments, producing a set of transaction clusters by clustering module 220 may include: (a) assuming an initial number of K multi-variant gaussian distributions of data; (b) selecting K initial values (e.g. mean and standard-deviation values) for the respective K multi-variant gaussian distributions; (c) calculating the expected value of log-likelihood function (e.g. calculating the probability that an FV belongs to a specific transaction cluster, given the K mean and standard-deviation values); and (d) adjusting the K mean and standard-deviation values to obtain maximum-likelihood. According to some embodiments, steps (c) and (d) may be repeated iteratively, until the algorithm converges, in the sense that the adjustment of the K values does not exceed a predefined threshold between two consecutive iterations.

According to some embodiments, processor 201 may be configured to extract an FV from at least one incoming requested transaction and associate the at least one requested transaction with a transaction cluster in the clustering model according to extracted FV. For example, the extracted FV may be associated with a transaction cluster according to a maximum-likelihood best fit algorithm, as known to persons skilled in the art of machine-learning.

According to some embodiments, processor 201 may be configured to calculate at least one GC for each transaction cluster and attribute the calculated GC to at least one received request, based on the association of the requested transaction with the transaction cluster.

For example, in the case of ME transactions, the GC may be selected from a list consisting of decline propensity, fraud propensity, chargeback propensity and expected service time, as elaborated further below. Clusters of ME transactions may be attributed an expected service time, and consequently incoming transaction requests that are associated with specific transaction clusters may also be attributed the same expected service time.

According to some embodiments, processor 201 may be configured to: (a) receive at least one incoming requested transaction, including a source node and a destination node; (b) produce a list, including a plurality of available routes for communicating the requested transaction in accordance with available resources of computer network 210 (e.g. by any dynamic routing protocol such as a “next-hop” forwarding protocol, as known to persons skilled in the art of computer networks); and (c) calculate at least one cost metric (e.g.: an expected latency) for each route between the source node and destination node in the computer network.

According to some embodiments, system 200 may include at least one neural network module 214, configured to produce at least one routing path selection (e.g. element 209′ of FIG. 2), associating at least one transaction with a routing path between a source node and a destination node of the computer network.

Embodiments may include a plurality of neural network modules 214, each dedicated to one respective cluster of clustering model 220, and each cluster of the clustering model associated with a one respective neural network module. Each neural network module 214, may be configured to select at least one routing path for at least one specific transaction associated with the respective cluster. This dedication of neural network modules 214 to respective clusters of clustering model 220 may facilitate efficient production of routing path selections for new transaction requests, according to training of the neural network modules on data derived from similar transactions.

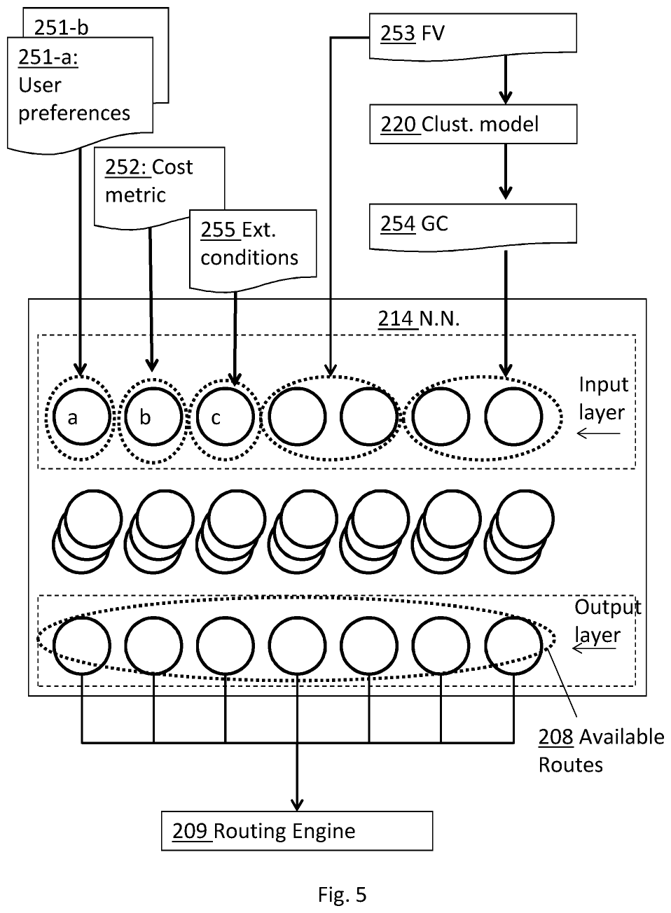

Reference is now made to FIG. 5, which is a block diagram depicting an exemplary implementation of neural network 214, including a plurality of network nodes (e.g. a, b, c etc.) according to some embodiments. In one embodiment a neural network may include an input layer of neurons, and an output layer of neurons, respectively configured to accept input and produce output, as known to persons skilled in the art of neural networks. The neural network may be a deep-learning neural network and may further include at least one internal layer of neurons, intricately connected among themselves (not shown in FIG. 5), as also known to persons skilled in the art of neural networks. Other structures of neural networks may be used.

According to some embodiments, neural network 214 may be configured to receive at least one of: a list including a plurality of available routing paths 208 from processor 201; at least one cost metric 252 associated with each available route; at least one requested transaction's FV 253; the at least one requested transactions GC 254; at least one user preference 251; and at least one external condition 255 (e.g. the time of day). Neural network 214 may be configured to generate at least one routing path selection according to the received input, to select at least one routing path for the at least one requested transaction from the plurality of available routing paths. As shown in the embodiment depicted in FIG. 5, user preference 251, cost metric 252, FV 253, GC 254 and external condition 255 may be provided to neural network 214 at an input layer, as known to persons skilled in the art of machine learning.

As shown in the embodiment depicted in FIG. 5, neural network 214 may have a plurality of nodes at an output layer. According to some embodiments, neural network 214 may implicitly contain routing selections for each possible transaction, encoded as internal states of neurons of the neural network 214. For example, neural network 214 may be trained to emit or produce a binary selection vector on an output layer of neural nodes. Each node may be associated with one available route, as calculated by processor 201. The value of the binary selection vector may be indicative of a selected routing path. For example, neural network 214 may emit a selection vector with the value ‘001’ on neural nodes of the output layer that may signify a selection of a first routing path in a list of routing paths, whereas a selection vector with the value ‘011’ may signify a selection of a third routing path in the list of routing paths.

According to some embodiments, neural network 214 may be configured to generate at least one routing path selection of an optimal routing path according to at least one cost metric 252.

For example: A user may purchase goods online through a website. The purchase may be conducted as an ME transaction between a source node (e.g. a banking server that handles the user's bank account) and a destination node (e.g. the merchant's destination terminal, which handles the merchant's bank account). The purchase may require at least one conversion of currency, and the user may prefer to route a transaction through a routing path that would minimize currency conversion costs. Processor 201 may calculate a plurality of available routing paths for the requested ME transaction (e.g. routes that pass via a plurality of banking servers, each having different currency conversion spread and markup rates) and calculate cost metrics (e.g. the currency conversion spread and markup) per each available transaction routing path. Neural network 214 may select a route that minimizes currency conversion costs according to these cost metrics.

In some embodiments, system 200 may be configured to select an optimal routing path according to a weighted plurality of cost metrics. Pertaining to the example above: the user may require, in addition to a minimal currency conversion cost, that the transaction's service time (e.g.: the period between sending an order to transfer funds and receiving a confirmation of payment) would be minimal. The user may provide a weighted value for each preference (e.g. minimal currency conversion cost and minimal service time), to determine an optimal routing path according to the plurality of predefined cost metrics.

In some embodiments, processor 201 may be configured to dynamically calculate a Net Present Value (NPV) cost metric per each available routing path. For example, consider two available routing paths for an ME transaction, where the first path includes at least a first intermediary node that is a banking server in a first country and the second path includes at least a second intermediary node that is a banking server in a second country. Assuming that the first and second banking servers operate at different times and work days, the decision of a routing path may incur considerable delay on one path in relation to the other. This relative delay of the ME transaction may, for example, affect the nominal amount and the NPV of the financial settlement.

In another example of an ME transaction, processor 201 may be configured to: determine a delay, in days (d), by which money will be released to a merchant according to each available routing path; obtain at least one interest rate (i) associated with at least one available routing path; and calculate a Present Value (PV) Loss value for the settlement currency used over each specific route according to Eq. 1 below:

PV Loss=Amount×(1+i)^{d} Eq. 1

In some embodiments, processor 201 may be configured to calculate a cost metric relating to transaction-fees per at least one available route. For example, in ME transactions, processor 201 may calculate the transaction fees incurred by routing the transaction through a specific route-path, by taking into account, for example: (a) a paying card's interchange fee (e.g.: as dictated by its product code and its issuing bank country); (b) additional fees applicable for specific transaction types (e.g.: purchase, refund, reversal, authorization, account validation, capture, fund transfer); (c) discount rate percentage applicable for specific transaction types; and (d) fixed fee as applicable for the specific type of transaction. The transaction fee cost metric may be calculated as shown below, in Eq. 2:

Fee=interchange+AdditionalFees+(Amount×DiscountRatePercentage)+FixedFee Eq. 2

According to some embodiments, system 200 may include a routing engine 402, configured to receive at least one requested transaction from processor 201, and a respective routing path selection from neural network 214, and route the requested transaction through network 210 according to the respective routing path selection. Pertaining to the ME transaction example above: routing engine 402 may receive a routing path selection, assigning an optimal routing path to a specific requested monetary transaction between the source node (e.g. a computer that handles the user's bank account) and the merchant's destination terminal (e.g. a banking server that handles the merchant's bank account).

Routing engine 209 may employ any suitable routing protocol known to a person skilled in the art of computer networks, to route at least one communication between the source node and the destination node via the selected optimal routing path, including for example: a funds transfer message from the source node to the destination node, and a payment confirmation message from the destination node back to the source node. In some embodiments, routing engine 209 may dictate or control a specific route for transaction by utilizing low-level functionality of an operating system (e.g. element 115 of FIG. 1) of a source node to transmit the transaction over a specific network interface to an IP address and port (e.g. a TCP socket) of a destination node.

According to some embodiments, processor 201 may be configured to accumulate historic information regarding the status of transactions and may store the accumulated information in a storage device (e.g. repository 203 of FIG. 4). Processor 201 may calculate at least one GC for at least one transaction cluster of clustering model 220 according to the stored information and attribute the at least one calculated GC to at least one received transaction request, based on the association of the requested transaction with the transaction cluster. Neural network 214 may consequently determine an optimal routing path according the at least one calculated GC, thereby reducing processing power after initial training of clustering model 220.

Pertaining to the example of ME transactions, GC may be selected from a list consisting of decline propensity, fraud propensity, chargeback propensity and expected service time. For example:

Processor 201 may accumulate status data per each transaction, including information regarding whether the transaction has been declined P_{decline}, and may calculate the decline propensity of each transaction cluster as the ratio between the non-declined transactions and the total number of transactions, as shown in Eq. 3:

$${P}_{decline} = \frac{\# \{ declined transactions \}}{\# \{ all transactions \}} \qquad Eq . 3$$

Processor 201 may accumulate status data per each transaction, including information regarding whether the transaction has been fraudulent, and may calculate the fraud propensity P_{fraud} of each transaction cluster as the ratio between the number of fraudulent transactions and the number of non-declined transactions, as shown in Eq. 4:

$${P}_{fraud} = \frac{\# \{ fraudulent transactions \}}{\# \{ all non \text{-} declined transactions \}} \qquad Eq . 4$$

Processor 201 may calculate the sum-weighted fraud propensity PW_{fraud} of each transaction cluster according to the ratio expressed in Eq. 5:

$${PW}_{fraud} = \frac{\sum ( \# fraudulent \text{-} transactions * transaction amount )}{\sum ( \# non \text{-} declined \text{-} transactions * transaction amount )} \qquad Eq . 5$$

According to some embodiments, at least one GC may be attributed to at least one subset of the overall group of transactions. For example, processor 201 may analyze a subset of transactions which is characterized by at least one common denominator (e.g. a common destination node) and attribute all transactions within this subset with a common GC (e.g. as having a high decline propensity).

According to some embodiments, at least one combination of at least one user preference 251, at least one cost metric 252 and at least one GC 254 may affect a selection of an optimal routing path by the neural network.

Pertaining to the example of ME transactions, a user may be, for example an individual (e.g. a consumer, a merchant, a person trading online in an online stock market, and the like), or an organization or institution (e.g. a bank or another financial institution). Each such user may define at least one preference 251 according to their inherent needs and interests. For example: a user may define a first preference 251-a for an ME transaction to maximize the NPV and define a second preference 251-b for the ME transaction to be performed with minimal fraud propensity. The user may define a weighted value for each of preferences 251-a and 251-b, that may affect the selection of an optimal routing path. For example:

If the weighted value for preference 251-a is larger than that of preference 251-b, a route that provides maximal NPV may be selected.

If the weighted value for preference 251-a is smaller than that of preference 251-b, a route that provides minimal fraud propensity may be selected.

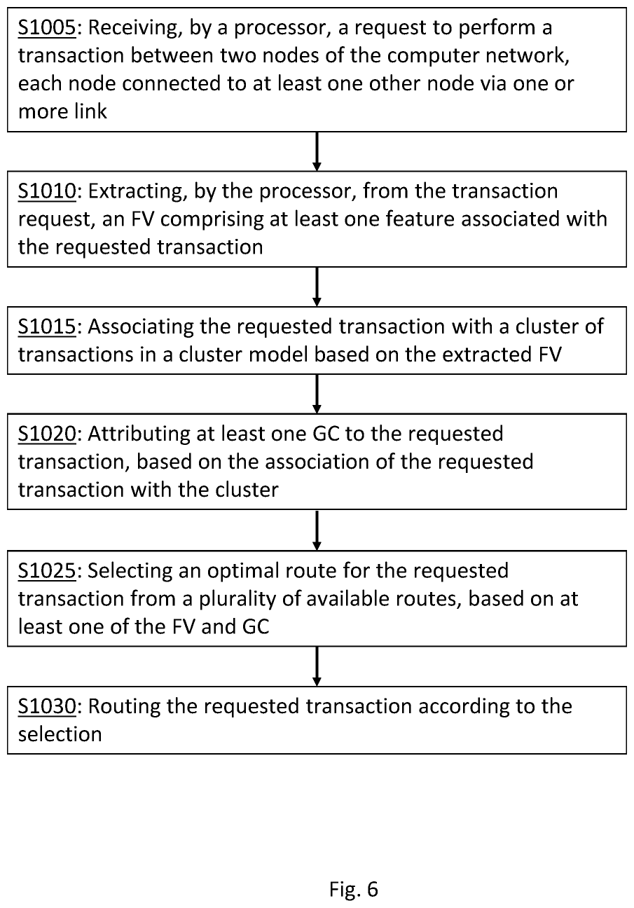

Reference is now made to FIG. 6, which is a flow diagram, depicting a method of routing transactions through a computer network according to some embodiments.

In step S1005, a processor may receive a request to perform a transaction between two nodes of a computer network, where each node may be connected to at least one other node via one or more links. For example, the requested transaction may be an ME transaction, meant to transfer funds between a first banking server and a second banking server.

In step S1010, the processor may extract from the transaction request, a feature vector (FV). The FV may include at least one feature associated with the requested transaction. In the example of the ME transaction above, the FV may include data pertaining to a type of the ME transaction (e.g.: purchase, refund, reversal, authorization, account validation, capture, fund transfer, etc.), a source node, a destination node, etc.

In step S1015, the processor may associate the requested transaction with a cluster of transactions in a clustering model based on the extracted FV. For example, the processor may implement a clustering module, comprising a plurality of transaction clusters, clustered according to at least one FV feature. The clustering module may be configured to associate the requested transaction with a transaction cluster by a best fit maximum likelihood algorithm.

In step S1020, the processor may attribute at least one GC (e.g.: fraud propensity) to the requested transaction, based on the association of the requested transaction with the cluster.

In step S1025, the processor may select an optimal route for the requested transaction from a plurality of available routes, based on at least one of the FV and GC.

In step S1030, the processor may route the requested transaction according to the selection. For example, the processor may emit a routing path selection, associating the requested transaction with a selected routing path within the computer network. According to some embodiments, a routing engine may receive the routing path selection from the processor and may dictate or control the routing of the requested transaction via the selected routing path.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system of routing transactions between nodes of a computer network, each node connected to at least one other node via one or more links, the system comprising:
a clustering model;
at least one neural network;
a routing engine; and
at least one processor,
wherein the at least one processor is configured to:
receive a request to route a transaction between two nodes of the computer network;
extract from the transaction request, a feature vector (FV), comprising at least one feature; and
associate the requested transaction with a cluster of transactions in the clustering model based on the extracted FV,
and wherein the neural network is configured to produce a selection of an optimal route for the requested transaction from a plurality of available routes, based on the FV,
and wherein the routing engine is configured to route the requested transaction according to the selection.

2. The system of claim 1, wherein the clustering model is configured to:
accumulate a plurality of FVs, each comprising at least one feature associated with a respective received transaction;
cluster the plurality of FVs to clusters, according to the at least one feature; and
associate at least one other requested transaction with a cluster, according to a maximum-likelihood best fit of the at least one other requested transaction's FV.

3. The system of claim 2, wherein the at least one processor is further configured to attribute at least one group characteristic (GC) to the requested transaction, based on the association of the requested transaction with the cluster, and wherein the neural network is configured to produce a selection of an optimal route for the requested transaction from a plurality of available routes, based on at least one of the FV and GC.

4. The system of claim 3, wherein the GC is selected from a list consisting of: decline propensity, fraud propensity, chargeback propensity and expected service time.

5. The system of claim 3, wherein the neural network is configured to select an optimal route for the requested transaction from a plurality of available routes, based on at least one of the FV and GC and at least one weighted user preference.

6. The system of claim 3, wherein the at least one processor is configured to calculate at least one cost metric, and wherein the neural network is configured to select an optimal route for the requested transaction from a plurality of available routes, based on at least one of the FV and GC, at least one weighted user preference, and the at least one calculated cost metric.

7. The system of claim 6, wherein the at least one cost metric is selected from a list consisting of: transaction fees per at least one available route, currency conversion spread and markup per the at least one available route and net present value (NPV) of the requested transaction per at least one available route.

8. The system of claim 2, wherein each cluster of the clustering model is associated with a respective neural network module, and wherein each neural network module is configured to select at least one routing path for at least one specific transaction associated with the respective cluster.

9. A method of routing transactions within a computer network, method comprising:
receiving, by a processor, a request to route a transaction between two nodes of the computer network, each node connected to at least one other node via one or more links;
extracting, by the processor, from the transaction request, a feature vector (FV), comprising at least one feature associated with the requested transaction;
associating the requested transaction with a cluster of transactions in a clustering model based on the extracted FV;
selecting an optimal route for the requested transaction from a plurality of available routes, based on the FV; and
routing the requested transaction according to the selection.

10. The method of claim 9, further comprising:
attributing, by the processor, at least one group characteristic (GC) to the requested transaction, based on the association of the requested transaction with the cluster;
selecting, by the processor, an optimal route for the requested transaction from a plurality of available routes based on at least one of the FV and GC.

11. The method of claim 10, further comprising:
receiving, by the processor, at least one at least one weighted user preference to the requested transaction;
selecting, by the processor, an optimal route for the requested transaction from a plurality of available routes based on at least one of the FV, GC and at least one weighted user preference.

12. The method of claim 9, wherein associating the requested transaction with a cluster comprises:
accumulating, by the processor, a plurality of FVs, each comprising at least one feature associated with a respective received transaction;
clustering the plurality of FVs to clusters in the clustering model, according to the at least one feature; and
associating at least one other requested transaction with a cluster according to a maximum-likelihood best fit of the at least one other requested transaction's FV.

13. The method of claim 10, wherein attributing at least one GC to the requested transaction comprises:
calculating at least one GC for each cluster; and
attributing the received request at least one calculated GC based on the association of the requested transaction with the cluster.

14. The method of claim 13, wherein the GC is selected from a list consisting of decline propensity, fraud propensity, chargeback propensity and expected service time.

15. The method of claim 9, wherein selecting an optimal route for the requested transaction from a plurality of available routes comprises:
providing at least one of an FV and a GC as a first input to a neural-network;
providing at least one cost metric as a second input to the neural-network;
providing the plurality of available routes as a third input to the neural-network; and
obtaining, from the neural-network a selection of an optimal route based on at least one of the first, second and third inputs.

16. The method of claim 15, further comprising: associating each cluster of the clustering model with a respective neural network module; and configuring each neural network to select at least one routing path for at least one specific transaction associated with the respective cluster.

17. The method of claim 15, wherein providing at least one cost metric comprises at least one of:
calculating transaction fees per at least one available route;
calculating currency conversion spread and markup per the at least one available route; and
calculating net present value of the requested transaction per at least one available route.

18. The method of claim 17, wherein providing at least one cost metric further comprises receiving at least one weight value and determining the cost metric per the at least one available route based on the calculations and the at least one weight value.

19. A computer readable medium comprising instructions which, when implemented in a processor in a computing system cause the system to implement a method according to claim 9.
